(19) United States
(12) Patent Application Publication
(10) Pub. No.: US 2014/0144716 A1
(43) Pub. Date: May 29, 2014

(54) CRAWLER TRACK TENSIONING ASSEMBLY

(71) Applicants: Joseph J. Wirkus, Germantown, WI (US); Guido Stanski, Waltrop (DE); Uwe Esch, Dortmund (DE)

(72) Inventors: Joseph J. Wirkus, Germantown, WI (US); Guido Stanski, Waltrop (DE); Uwe Esch, Dortmund (DE)

(21) Appl. No.: 13/699,921

(22) PCT Filed: May 26, 2011
(86) PCT No.: PCT/US11/38060

§ 371 Date: Feb. 13, 2013

Related U.S. Application Data
(60) Provisional application No. 61/350,262, filed on Jun. 1, 2010.

(51) Int. Cl. B62D 55/30; B62D 55/06

(52) U.S. Cl. CPC B62D 55/30; B62D 55/06
USPC 180/9.1; 305/145

(57) ABSTRACT

A track tensioning assembly rotatably supports an idler wheel and actuator to simplify maintenance and repair. The track tensioning assembly can be provided in a crawler tack assembly forming part of a work machine, and includes a sliding frame with an idler wheel rotatably mounted on the sliding frame. A hydraulic actuator including a cylinder is mounted to the sliding frame. A ram extends from the cylinder away from the idler wheel, and includes a rod port extending through the ram for supplying hydraulic fluid to the actuator.

### CROSS REFERENCE TO RELATED APPLICATIONS

This application claims the benefit of U.S. Patent Application No. 61/350,262, filed on Jun. 1, 2010, including the specification, drawings, claims and abstract, which are incorporated herein by reference in their entirety.

### STATEMENT REGARDING FEDERALLY SPONSORED RESEARCH

Not Applicable.

### FIELD OF INVENTION

This invention relates to a work machine crawler track, and particularly to a track tensioning assembly for use in a work machine crawler track.

### BACKGROUND OF INVENTION

Work machines, such as excavators, include a base supported by a pair of ground engaging crawler tracks. The base rotatably supports a frame on which is mounted a housing for protecting work machine components, such as power generation equipment, electrical equipment, a dipper hoist, and controls in an electric work machine or power generation equipment, electrical equipment, hydraulic pumps, and controls in a hydraulic work machine. The frame can also support a dipper assembly and boom. The dipper assembly includes a dipper, or bucket, that engages the ground.

Each crawler track includes interconnected crawler links forming a chain wrapped around a track frame. The chain is propelled around the track frame by a crawler sprocket rotatably driven by a propel drive system. The chain is carried around the track frame by track rollers and guided around the frame ends by idler wheels, all of which are mounted to the frame. Over time, the chain stretches causing the chain to vibrate and bounce as it travels around the track frame. In addition, rocks and foreign objects caught between links can increase track tension above a desirable level.

Prior art crawler tracks addressed these problems by providing an idler wheel frame assembly including an idler wheel on a biased slidable idler wheel frame to maintain tension in the chain and allow a certain amount of recoil. The idler wheel frame that rotatably supports the idler wheel. A biasing member, such as a spring or hydraulic actuator, biases the idler wheel frame outwardly urging the idler wheel into engagement with the chain. If a hydraulic actuator is incorporated into the idler wheel frame assembly to urge the idler wheel into engagement with the chain, the hydraulic cylinder is fixed to the track frame and an extendible rod urges the idler wheel frame outwardly to maintain engagement of the idler wheel with the chain.

Maintenance of prior art idler wheel frame assemblies incorporating a hydraulic actuator to bias a slidable idler wheel frame is very difficult because of the massive weight of the cylinder forming part of the hydraulic actuator. Typically the cylinder must be pulled along the cylinders longitudinal axis prior to lifting the cylinder with a crane or other piece of heavy machinery. Therefore, a need exists for an idler wheel frame assembly that is easier to maintain.

### SUMMARY OF THE INVENTION

The present invention provides a track tensioning assembly that rotatably supports the idler wheel and the biasing member to simplify maintenance and repair. The track tensioning assembly can be provided in a crawler tack assembly forming part of a work machine, and includes a sliding frame with an idler wheel rotatably mounted on the sliding frame. A hydraulic actuator including a cylinder is mounted to the sliding frame. A ram extends from the cylinder away from the idler wheel, and includes a rod port extending through the ram for supplying hydraulic fluid to the actuator. Advantageously, mounting the cylinders to the sliding frame allows relatively easy removal of the assembly from a track frame. As a result, replacement of the cylinders fixed to the sliding frame is simplified compared to assemblies having the cylinders mounted to the fixed frame.

A general objective of the present invention is to provide a track tensioning assembly that is easily maintained. This objective is accomplished by mounting the actuators, and thus the cylinders, to the sliding frame, such that the cylinders and sliding frame can be removed from a track frame as a unit.

The foregoing and other objects and advantages of the invention will appear from the following detailed description. In the description, reference is made to the accompanying drawings which illustrate a preferred embodiment of the invention.

### BRIEF DESCRIPTION OF THE DRAWINGS

FIG. 1 is a side view of an hydraulic excavator;

FIG. 2 is a perspective view of a crawler track assembly incorporating the present invention;

FIG. 3 is a detailed perspective cutaway view along line 3-3 of the crawler truck of FIG. 2;

FIG. 4 is a perspective view of the modular track tensioning assembly of FIG. 3; and

FIG. 5 is a sectional view of a hydraulic actuator of FIG. 4.

### DETAILED DESCRIPTION OF THE PREFERRED EMBODIMENT

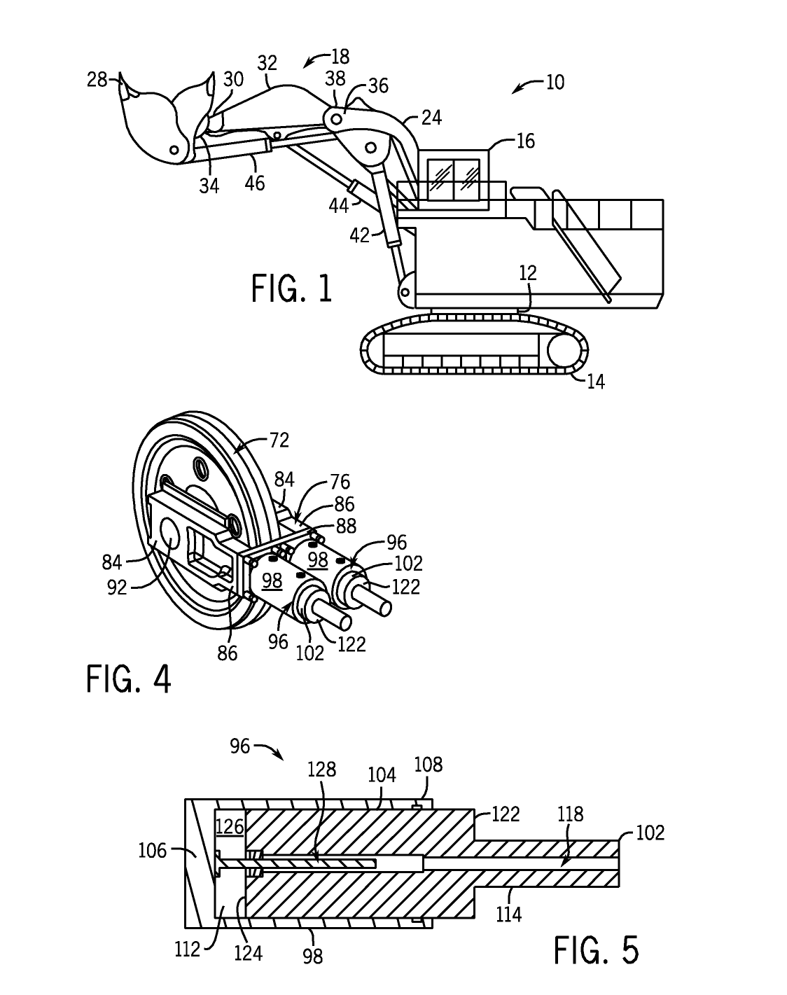

Referring to FIG. 1, a hydraulic excavator 10 is shown. The excavator 10 includes a turntable 12 supported above the ground by a pair of ground engaging crawler track assemblies 14. The rotatable turntable 12 supports a cab 16 and working equipment 18. The cab 16 houses a power unit including a hydraulic control system and an electrical control system that operates the excavator working equipment 18 in response to inputs from the operator and automatic devices, such as limit switches, pressure switches, temperature switches, and the like. The operator can provide inputs from within the cab through manually operable devices, such as a joystick, lever, foot pedals, rocker switches, computer keyboard, touch pads, and the like.

The working equipment 18 includes a boom 24 having a lower end pivotally attached to the turntable 12 at a boom pivotal connection. A bucket, or dipper, 28 is pivotally mounted on the front end 30 of a stick 32 at a dipper pivotal connection 34. The stick 32 is pivotally connected to an upper end 36 of the boom 24 at a stick pivotal connection 38. A boom hydraulic cylinder 42 pivots the boom 24 about the boom pivotal connection to raise and lower the boom upper end 36. A stick hydraulic cylinder 44 pivots the stick 32 about the stick pivotal connection 38 to extend and retract the stick front end 30. Finally, a dipper hydraulic cylinder 46 pivots the dipper 28 about the dipper pivotal connection 34 to scoop and dump material in the dipper 28. Although a hydraulic excavator is shown, the crawler track tensioning assembly described herein can be used with other crawler track supported work machine, such as rope shovels, drag lines, bulldozers, cranes, and the like, without departing from the scope of the invention.

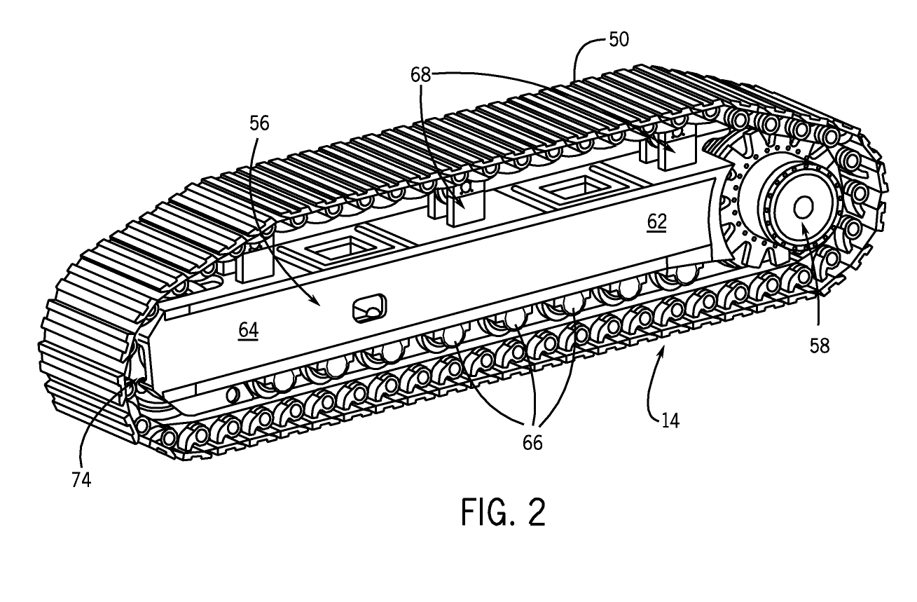

Referring to FIGS. 2-5, each crawler track assembly 14 includes interconnected crawler links 52 joined by track pins to form a track 50 wrapped around a track frame 56. The track 50 is propelled around the track frame 56 by a crawler sprocket 58 mounted at one end 62 of the track frame 56. The track 50 is carried around the track frame 56 by track rollers 66 and support rollers 68 and is guided around the track frame ends 62, 64 by the crawler sprocket 58 and an idler wheel 72. In the embodiment disclosed herein, eight track rollers 66 rotatably mounted to a bottom surface of the track frame 56 and three support rollers 68 rotatably fixed relative to an upper surface of the track frame 56 are shown. However, any number of track and support rollers can be provided without departing from the scope of the invention.

Tension in the track 50 wrapped around the track frame 56 is maintained by a modular track tensioning assembly 74 including the idler wheel 72 rotatably mounted on a sliding frame 76. The sliding frame 76 is slidably received in a slot 78 formed in an end 64 of the track frame 56 opposite the end 62 supporting the crawler sprocket 58. The sliding frame 76 is slidable in the slot 78 along a longitudinal axis 82 defined by the slot 78 and includes a pair of spaced support arms 84 joined at one end 86 by a cross plate 88. The idler wheel 72 is rotatably mounted between the support arms 84 by a pin 92 extending through the space between the support arms 84.

A pair of single acting hydraulic actuators 96 mounted to the sliding frame 76 slidably move the sliding frame 76 in the slot 78 relative to the track frame 56 along the longitudinal axis 82. Each hydraulic actuator 96 includes a cylinder 98 fixed to the cross plate 88 and a ram 102 abutting the track frame 56. Actuation of the actuators 96 slidably moves the cylinders 98, and thus the sliding frame 76, relative to the track frame 56 to adjust the tension in the track 50 engaging the idler wheel 72. Advantageously, mounting the cylinders 98 to the sliding frame 76 allows relatively easy removal of the modular assembly 74 from the track frame 56. As a result, replacement of the cylinders 98 fixed to the sliding frame 76 is simplified compared to assemblies having the cylinders mounted to the fixed frame.

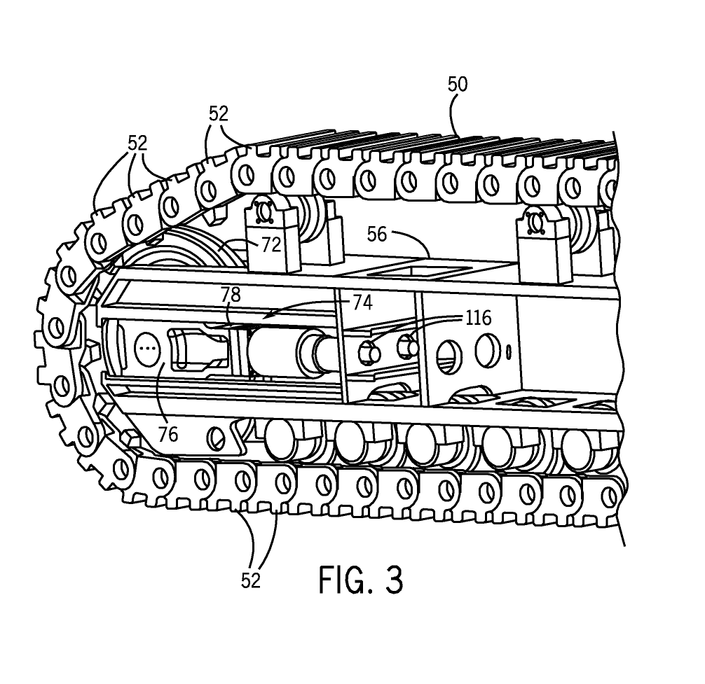

Each hydraulic actuator 96, shown in more detail in FIGS. 4 and 5, includes the hollow cylinder 98 having a cylinder wall 104, a blind end 106, and a rod end 108 which defines a fluid chamber 112 in the cylinder 98. A distal end 114 of the ram 102 extends out of the rod end 108 and through an aperture 116, shown in FIG. 3, in the track frame 56 for connection to a hose supplying hydraulic fluid to the hydraulic cylinder through a rod port 118 extending through the ram 102. A shoulder 122 formed in the ram 102 proximal the ram distal end 114 abuts the track frame 56 to urge the sliding frame 76 outwardly to tension the track 50 engaging the idler wheel 72.

An inner end 124 of the ram 102 extends into the fluid chamber 112 through the rod end 108 of the cylinder 98. The ram 102 sealingly engages the cylinder wall 104 of the cylinder 98 to define an extension chamber 126 between the ram inner end 124 and blind end 106 of the cylinder 98. A seal can be provided between the ram 102 and cylinder wall 104 to prevent hydraulic fluid from leaking therebetween and out of the cylinder rod end 108. The rod port 118 in fluid communication with the extension chamber 126 through the ram 102 supplies hydraulic fluid to the extension chamber 126 to expand the extension chamber 126 and urge the idler wheel 72 against the track 50 to increase the tension in the track 50 engaging the idler wheel 72. Advantageously, the ram 102 remains stationary with respect to the track frame 56. As a result, providing hydraulic fluid to the extension chamber 126 through the rod port 118 ensures that hydraulic hoses supplying hydraulic fluid to the actuator 96 do not experience excessive movement during normal operation of the system.

A ram position sensing electronic device 128 within at least one of the cylinders 98 senses the position of the ram 102 in the cylinder 98 relative to the blind end 106 of the cylinder 98. The position sensing electronic device 128 provides a signal to the excavator control system proportional to the extension of the ram 102. The control system uses this signal to determine track stretch which is evidence of gage track pin wear, roller path wear, as well as back and forth movements inherent in the crawler track 50. Advantageously, by providing the position sensing electronic device 128 inside the cylinder 98, the device 128 is protected from the harsh operating conditions experienced by the excavator 10.

Hydraulic fluid is supplied to the actuators 96 through the ram port 118 of each actuator 96 by an accumulator hydraulic circuit. The accumulator hydraulic circuit provides hydraulic fluid to the actuators 96 within a predetermined pressure range. A pressure sensing electronic device in the hydraulic circuit provides feedback of system pressure and monitor the hydraulic fluid pressure. The hydraulic fluid pressure in the accumulator hydraulic circuit is monitored for a sudden event in which high pressure is detected indicating the potential occurrence of an overload or damaging event experienced by the crawler track 50. The sudden high pressure event is recorded by the control system to issue an alarm or maintenance report for follow up by a technician. A hydraulic pressure relief valve can also be provided in the accumulator hydraulic circuit for reducing pressure in the circuit in the event the pressure in the hydraulic circuit exceeds a predetermined level in order to protect the accumulator hydraulic circuit components and connecting hoses from failure.

In use, the track tensioning assembly 74 maintains a desired track tension in one moving direction and limits the amount of slack in the track 50 in an opposite moving direction. In particular, when power is applied to rotatably drive the sprocket 50 and propel the excavator 10, in either forward or backward direction, each track tensioning assembly 74 maintains tension within each track 50. In the forward moving direction, a predetermined amount of track tension is maintained by pumping hydraulic fluid into the extension chamber 126 of each actuator 96 until a predetermined hydraulic fluid pressure is achieved.

In the backward moving direction, track tension is dictated by the hydraulic fluid pressure in the accumulator circuit, the tension in the crawler track 50 from the machine propel motion causes the assembly to react, thereby compressing the actuators 96. As gas within the accumulators in the hydraulic circuit is compressed, the pressure in the actuators 96 increases, and finally the hydraulic fluid from the actuators 96 is forced out of the extension chamber 126 of each actuator through the respective rod ports 118 and over a hydraulic pressure relief valve, thereby limiting the amount of slack possible in the tracks 50.

Access to the actuators 96 for replacement or repair is accomplished by removing the track 50 from around the idler wheel 72 and disconnecting the hoses supplying hydraulic fluid to the actuators 96 mounted to the sliding frame 76. The sliding frame 76 is then slid out of the track frame 56 to provide access to the actuators 96. Advantageously, the actuators 96 are more easily accessed when removed from the track frame 56 with the sliding frame 76 compared to actuators that remain fixed to the track frame 56 upon removal of the sliding frame 76.

While there has been shown and described what are at present considered the preferred embodiments of the invention, it will be obvious to those skilled in the art that various changes and modifications can be made therein without departing from the scope of the invention defined by the appended claims.

What is claimed is:

1. A track tensioning assembly comprising:
a sliding frame;
an idler wheel rotatably mounted on said frame;
a hydraulic actuator including a cylinder mounted to said sliding frame;
a ram extending from said cylinder away from said idler wheel, said ram including a rod port extending through said ram.

2. The track tensioning assembly as in claim 1, including a ram position sensor sensing an axial position of said ram in said cylinder.

3. The track tensioning assembly as in claim 2, in which said ram position sensor is disposed in said cylinder.

4. The track tensioning assembly as in claim 2, including a pressure sensor monitoring a pressure of hydraulic fluid supplied to said hydraulic actuator through said rod port, wherein a control system records a pressure above a predetermined level detected by said pressure sensor corresponding with a change in position of said ram detected by said ram position sensor indicating an event affecting said crawler track assembly.

5. The track tensioning assembly as in claim 1, in which said sliding frames includes a pair of spaced support arms, and said idler wheel is rotatably mounted between said support arms.

6. The track tensioning assembly as in claim 5, in which said support arms are joined at one end by a cross plate, and said cylinder is fixed to said cross plate.

7. A crawler track assembly comprising:
a track frame slidably receiving said track tensioning assembly as in claim 1, wherein a portion of a distal end of said ram proximal abuts said track frame, and actuation of said hydraulic actuator slidably moves said sliding frame relative to said track frame.

8. The crawler track assembly as in claim 7, including a track wrapping around said track frame and engaging said idler wheel.

9. The crawler track assembly as in claim 8, in which said idler wheel engages said track at one end of said track frame and a drive sprocket engages said track at an opposing end of said track frame.

10. The crawler track assembly as in claim 7, including a source of hydraulic fluid in fluid communication with said rod port.

11. The crawler track assembly as in claim 10, in which said source of hydraulic fluid is in fluid communication with said rod port via a hose.

12. The crawler track assembly as in claim 10, in which said source of hydraulic fluid is an accumulator circuit.

13. A work machine including the crawler track assembly as in claim 7.

14. The work machine as in claim 13, including a ram position sensor sensing an axial position of said ram in said cylinder.

15. The work machine as in claim 14, including a control system controlling components of said work machine, said work machine further including a pressure sensor monitoring a pressure of hydraulic fluid supplied to said hydraulic actuator through said rod port, wherein said control system records a pressure above a predetermined level detected by said pressure sensor corresponding with a change in position of said ram detected by said ram position sensor indicating an event affecting said crawler track assembly.

16. The work machine as in claim 14, in which said ram position sensor provides a signal to a control system proportional to said axial position of said ram.
